(19) United States
(12) Patent Application Publication
(10) Pub. No.: US 2018/0350360 A1
(43) Pub. Date: Dec. 6, 2018

(54) PROVIDE NON-OBTRUSIVE OUTPUT

(71) Applicant: Lenovo (Singapore) Pte. Ltd., Singapore (SG)

(72) Inventors: Ryan Charles Knudson, Durham, NC (US); Timothy Winthrop Kingsbury, Cary, NC (US); Christopher Donald Oman, Fort Wayne, IN (US); Matthew Jacyno, Fort Wayne, IN (US)

(21) Appl. No.: 15/609,348

(22) Filed: May 31, 2017

(51) Int. Cl. G10L 15/22; G06F 17/30; G10L 21/0272; G10L 15/08; G10L 25/51; G10L 25/87

(52) U.S. Cl. CPC G10L 15/22; G06F 17/30684; G10L 21/0272; G10L 2015/227; G10L 25/51; G10L 25/87; G10L 2015/088; G10L 15/08

(57) ABSTRACT

One embodiment provides a method, including: detecting, using at least one sensor associated with an information handling device, a conversation between at least two people; determining whether the information handling device can provide output to assist the at least two people during the conversation; and providing, responsive to determining that the information handling device can provide output to assist, output at a non-obtrusive point in the conversation. Other aspects are described and claimed.

### BACKGROUND

Information handling devices (“devices”), for example laptop and desktop computers, smart phones, tablet devices, smart speakers, and the like, may be disposed with virtual assistants that are capable of receiving user inputs (e.g., queries, commands, etc.) and providing outputs responsive to the input. Conventional virtual assistants need to be activated, or “waken”, by way of a predetermined input, e.g., by audibly saying the virtual assistant's “name”. Once a virtual assistant is activated, or “wakened” by a user, it may respond to queries presented by the user.

### BRIEF SUMMARY

In summary, one aspect provides a method, comprising: detecting, using at least one sensor associated with an information handling device, a conversation between at least two people; determining whether the information handling device can provide output to assist the at least two people during the conversation; and providing, responsive to determining that the information handling device can provide output to assist, output at a non-obtrusive point in the conversation.

Another aspect provides an information handling device, comprising: at least one sensor; a processor; a memory device that stores instructions executable by the processor to: detect a conversation between at least two people; determine whether the information handing device can provide output to assist the at least two people during the conversation; and provide, responsive to determining that the information handling device can provide output to assist, output at a non-obtrusive point in the conversation.

A further aspect provides a product, comprising: a storage device that stores code, the code being executable by a processor and comprising: code that detects a conversation between at least two people; code that determines whether an information handling device can provide output to assist the at least two people during the conversation; and code that provides, responsive to determining that the information handling device can provide output to assist, output at a non-obtrusive point in the conversation.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of determining whether a device may be able to provide assistive output during a non-obtrusive point in a conversation.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many devices may be disposed with a variety of always-on technologies, such as microphones, cameras, ambient light sensors, and the like. Conventionally, these always-on technologies are capable of continuously being able to accept input (e.g., user input, ambient sound or light input, picture input, etc.). For example, a digital assistant (e.g., Alexa® for Amazon®, Siri® for Apple®, Cortana® for Microsoft®, etc.) may contain a microphone that may continuously listen for user provided commands or queries and provide responsive output.

Conventionally, prior to providing the command or query input, currently available commercial systems require the device to be “awoken”, or activated, by a wake word or phrase provided by the user. For example, a user may say “Hey Siri” while using a device running iOS 8 or later or say “Alexa” while using a dedicated smart speaker such as the Echo®. Once a user provides a wake word, the device is activated and subsequently listens for voice commands following the wake word. Another method of activating the device requires the pressing of a particular button (e.g., pressing and holding the home button to activate Siri® virtual assistant, or pressing and holding the search button to activate Cortana® virtual assistant, etc.). Yet another method of activating a device pertains to a “raise to speak” function, wherein a user raises a device (e.g., a mobile device, etc.) and the motion is detected (e.g., using an accelerometer, etc.) and activates the device.

One issue with the current methods of activating a digital assistant is that they tend to disrupt whatever task the user is currently involved in. For example, conventional techniques are disruptive if a user is involved in performing a task that requires use of their hands (e.g., driving, cooking, etc.) or, if a user is engaged in a conversation with one or more other individuals. Regarding the latter, existing methods require an entire full-stop to the conversation in order to provide a wake word followed by a command and/or query. Additionally, with regard to wake words or phrases, their constant and repetitive nature creates a burden on the user and undercuts the benefit of the natural language aspect of the digital assistant.

Accordingly, an embodiment provides a method for determining whether a device may be able to provide assistive output during a non-obtrusive point in a conversation. In an embodiment, a conversation between at least two people may be detected using at least one sensor (e.g., a microphone, a camera, a combination thereof, etc.). An embodiment may then analyze the conversation to determine whether output may be provided to assist the users having the conversation (e.g., by identifying one or more discourse markers, by identifying a pause, etc.). In an embodiment, the output may be provided without user input explicitly requesting assistive output. Responsive to determining that the assistive output can be provided, an embodiment may provide output at a non-obtrusive point in the conversation (e.g., a point associated with a discourse marker, a point during which no dialogue is being exchanged, etc.). Such a method may enable virtual assistants to determine when they are needed without requiring a user to explicitly activate them. Additionally, the method does not require that a user explicitly provide or repeat the query or command after the device is activated.

The illustrated example embodiments will be best understood by reference to the figures. The following description is intended only by way of example, and simply illustrates certain example embodiments.

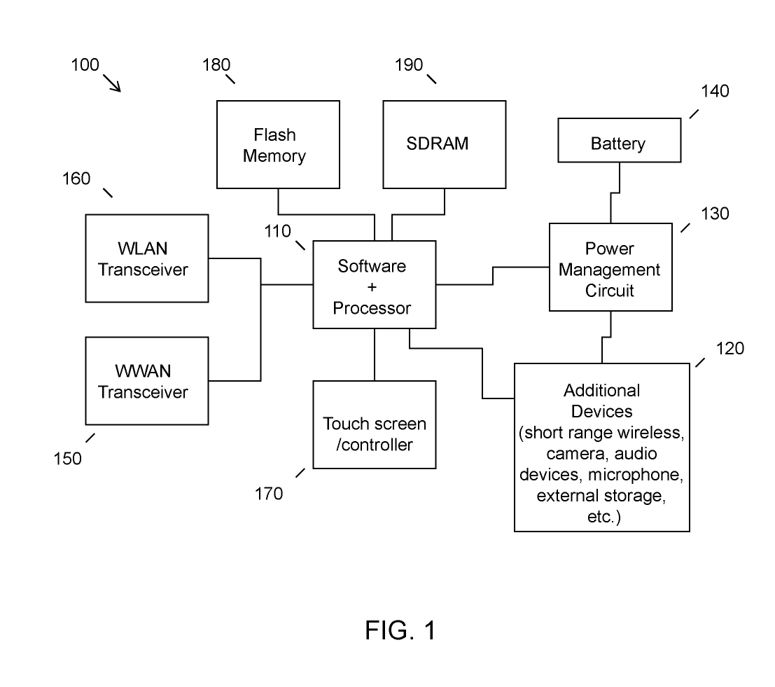

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

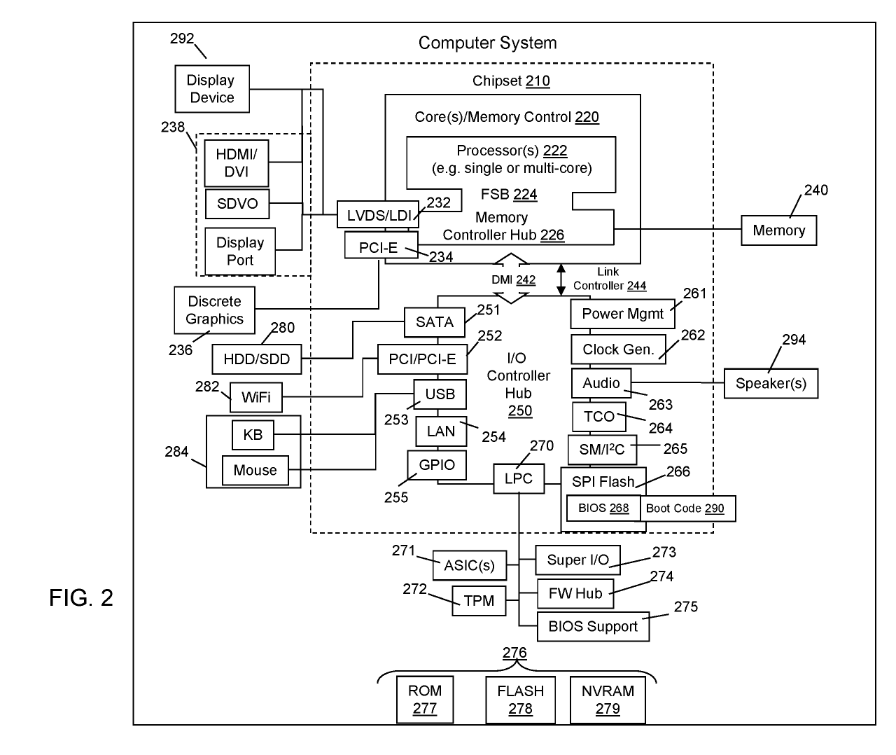

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

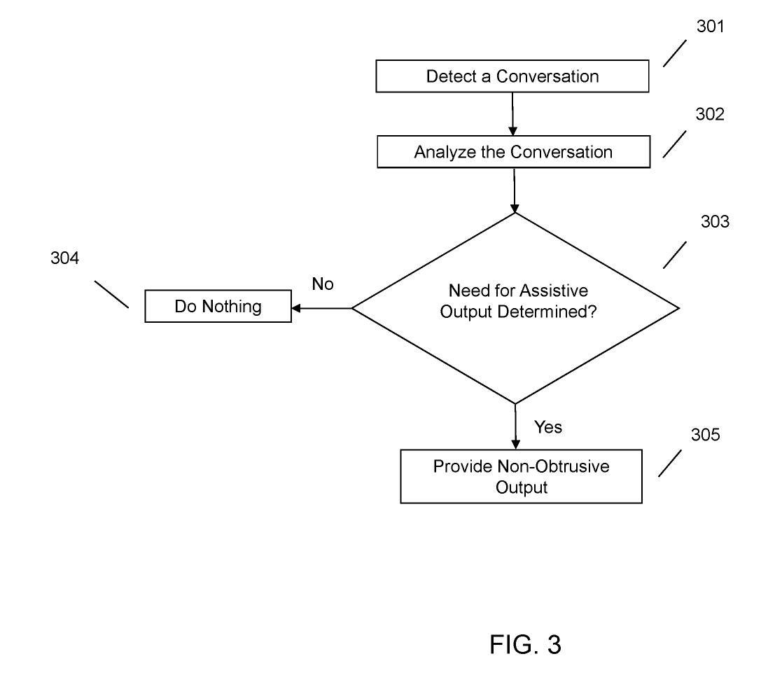

Referring now to FIG. 3, an embodiment may determine whether assistive output may be provided by a device and may then provide contextually relevant output at a non-obtrusive point in a conversation. At 301, an embodiment may detect a conversation between at least two people. The conversation may be a private conversation (e.g., conducted between two people over dinner, etc.) or, alternatively, may be a group-based conversation (e.g., conducted between multiple people in a business meeting, etc.). In an embodiment, the conversation may be detected by utilizing at least one sensor (e.g., a microphone, a camera, another audio or video capture device, a combination thereof, etc.) associated with a device. For simplicity purposes, the majority of the discussion herein will involve detection of an audible conversation using an audio capture device (e.g., a microphone, etc.). However, it should be understood that other sensors (e.g., cameras, etc.) may be utilized to detect all kinds of conversations (e.g., audible conversations, inaudible signed conversations, etc.).

In an embodiment, the sensor may be a sensor integral to the device. For example, a smart phone may be disposed with a microphone capable of detecting conversation-related data. Alternatively, the sensor may be disposed on another device and may transmit detected conversation-related data to the device. For example, a smart speaker may detect a nearby conversation and subsequently transmit that data to another device (e.g., to a user's smartphone, tablet, etc.). Conversation-related data may be communicated from other sources to the device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the sensor may continuously detect conversation-related data by maintaining the sensor in an active state. The sensor may, for example, continuously detect conversation-related data even when other sensors (e.g., cameras, light sensors, speakers, other microphones, etc.) associated with the device are inactive. Alternatively, the sensor may remain in an active state for a predetermined amount of time (e.g., 30 minutes, 1 hour, 2 hours, etc.). Subsequent to not detecting any conversation-related data during this predetermined time window, an embodiment may switch the sensor to a power off state. The predetermined time window may be preconfigured by a manufacturer or, alternatively, may be configured and set by one or more users. The active state of the sensor may be based upon a schedule of a user. For example, the user may set a schedule indicating when the user will be engaged in a conversation (e.g., a business meeting, etc.) near the device. Accordingly, the sensor may only be active when the user's schedule indicates the user will be near the device.

An embodiment may be able to differentiate between conversation-related data and other user inputs provided to a device (e.g., other user-provided commands, queries, etc.). For example, an embodiment may determine that a user is communicating with at least one other person by identifying voice inputs belonging to different users (e.g., through spectrogram analysis of the voice input, by distinguishing the voices, based upon detection of multiple devices, etc.) and determining (e.g., through contextual analysis of the voice input, etc.) that the voice inputs are associated with a conversation between the users and not explicitly directed to the device. In another example, an embodiment may be able to differentiate between conversation-related input and other user inputs by identifying that the voice inputs do not comprise a wakeup word or phrase meant to activate or ready the device to receive user-provided input.

At 302, an embodiment may analyze the conversation to determine various characteristics and/or a context associated with the conversation. The analysis may be conducted, for example, using known conversational analysis techniques (e.g., spectrogram analysis, speech parsing, etc.). In an embodiment, the conversation may be analyzed up to N-number (e.g., 5, 25, 100, etc.) of previous exchanges between the users. For example, an embodiment may analyze and refer to the past ten exchanges between the users where one exchange comprises a communication provided from one user to the other. The N-number may be configured by a user or may be pre-configured (e.g., by the manufacturer and/or programmer, etc.). Such a method enables the device to attain data that is relevant to the most recent point in a user's current conversation. In the same vein, in another embodiment, only the past N-time frame of a conversation may be analyzed. For example, only the past two minutes of a conversation may be analyzed. In an embodiment, the analysis may be conducted in real-time. For example, as input between users is detected, an embodiment may immediately, or substantially immediately, analyze the input.

In an embodiment, the conversation may be analyzed to identify any discourse markers present in the conversation. Discourse markers are words or phrases that individuals use to organize and/or manage the flow of discourse. Commonly used discourse markers are words or phrases like “so”, “well”, “anyway”, “right”, and “okay”. For example, a sample conversation containing discourse markers may resemble the following example conversation: User A: “So, I've decided I'm going to travel to New York City to see the concert”; User B: “Well, you need a car”; User A: “Right”.

In an embodiment, the conversation may be analyzed to identify any pauses, or lulls, in the conversation. A pause may be a point in a conversation where none of the participants provide input for a predetermined length of time (e.g., 5 seconds, 10 seconds, etc.). An embodiment may also identify any “filled pauses” present in the conversation. Filled pauses are filler words, or sounds, that individuals commonly use in discourse while thinking of an answer to a question or are processing a thought. Examples of commonly used filled pauses include filler words and sounds such as “uh”, “um”, “hmm”, and “like”. A sample conversation containing filled pauses may resemble the following: User A: “Do you know what time it is?”; User B: “umm, I think it is 5 o'clock”.

In an embodiment, the conversation may be analyzed to identify any trigger words or phrases that naturally imply a need for assistive output. Commonly used trigger words implying a need for output include “I don't know”, “I'm not sure”, “maybe”, and the like. For example, responsive to User A asking the question “Do you know what time it is?” User B may respond “I don't know”.

An embodiment may use data obtained from the conversation analysis to determine, at 303, whether assistive output may be provided. In an embodiment, the determination may be based on one or more identified discourse markers and/or pauses within a context of the conversation. For example, a certain discourse marker may imply a need for assistive output. Using the aforementioned conversation regarding traveling to New York, an embodiment may determine that assistive output may be helpful after the discourse marker “Right”. Such an output may resemble a suggestion listing of nearby car dealerships that may loan out cars.

In an embodiment, the determination may be based on the length and/or position of an identified pause. For example, if a length of a pause exceeds a predetermined threshold (e.g., 5 seconds, etc.), an embodiment may conclude that the lengthy pause may be indicative of a user thinking of an answer to a question and may determine that output is required. In an embodiment, the determination may be based on the identification and/or length of filler words or sounds. For example, using the aforementioned example regarding a user being queried for the time, an embodiment may identify the filled pause “umm” and determine that User B does not know the time or is searching for the time. An embodiment may therefore access, for example, date/time data and provide output indicating the current time. Persons having ordinary skill in the art will recognize that the aforementioned examples are non-limiting and other methods for determining whether assistive output may be provided are possible.

Responsive to determining, at 303, that assistive output can be provided or may be helpful, an embodiment may provide, at 305, output at a non-obtrusive point in the conversation. In an embodiment, the output may be audio output, visual output, a combination thereof, or the like. In an embodiment, the audible output may be provided through a speaker, another output device, and the like. In an embodiment, the visual output may be provided through a display screen, another display device, and the like. Visual output may be useful, for example, for one or more hearing impaired users who may communicate through sign language and the like. In an embodiment, the output device may be integral to the device or may be located on another device. In the case of the latter, the output device may be connected via a wireless or wired connection to the device. For example, a smart phone may provide instructions to provide audible output through an operatively coupled smart speaker. In an embodiment, the output may be provided without a user explicitly requesting that output should be provided.

In an embodiment, the output may be provided at a non-obtrusive point in the conversation. In an embodiment, the non-obtrusive point may be a point where an embodiment determines that a user, or a group of users, are amenable to receiving assistive output.

In an embodiment, the non-obtrusive point may be associated with a conversational element such as a discourse marker, a pause, a filler word or sound, an implied trigger word, and the like. That is, when an embodiment detects at least one of the aforementioned conversational elements, an embodiment may identify a time substantially immediately after (e.g. 1 second after, etc.) the occurrence of the conversational element as a non-obtrusive point in the conversation. For example, an embodiment may identify that a point immediately after the utterance of the trigger word “I don't know” is a non-obtrusive point in the conversation where the user is amenable to receiving output provided by a device. An embodiment may thereafter provide output at, or substantially close to, the non-obtrusive point.

In an embodiment, the non-obtrusive point may be associated with a change in a user's tone and/or an inflection in their voice as they pronounce a word or phrase. For example, using the aforementioned conversational example regarding taking a trip to New York, User A may lower their voice and/or change their vocal inflection as they provide the response, “Right”. Such a change in volume and/or vocal inflection during the pronunciation of the discourse marker may indicate that a user is unsure of how to proceed. An embodiment may detect this change and identify it as not only an indication that assistive output may be helpful, but also as a non-obtrusive point where the user is amenable to receiving output.

In an embodiment, the non-obtrusive point may be a crowdsourced non-obtrusive point. The crowdsourced non-obtrusive point may correspond to common non-obtrusive points in previous dialogues. In determining a crowdsourced non-obtrusive point, an embodiment may access a database containing identified non-obtrusive points from previous dialogues from a plurality of users. For example, an embodiment may identify (e.g., by accessing a database of stored dialogues, etc.) that the most commonly identified non-obtrusive point in conversations between users is a pause of 3 or more seconds. Subsequent to this identification, an embodiment may provide output during a user's conversation when it has identified a pause lasting 3 or more seconds.

In an embodiment, a device may learn to identify non-obtrusive points in a conversation that are particular to an individual user or a group of users. In an embodiment, a user may explicitly communicate to the device that output provided at a certain point is non-obtrusive (e.g., by saying “that was a good place to provide output”, etc.). In another embodiment, an embodiment may dynamically determine that output provided at a certain point is non-obtrusive by identifying at least one of a number of different contextual situations (e.g., by subsequently receiving the user-provided input “thanks”, by subsequently not receiving the user-provided input “be quiet”, by identifying that a user has used the information provided in the output as part of their continued conversation, etc.). In an example scenario, an embodiment may identify that a user provided the responsive input “thanks” when a device provided output after a user used the filler word “hmm” in conversation. An embodiment may determine that output provided after the filler word “hmm” is associated with a non-obtrusive point and may store this association in an accessible database. An embodiment may thereafter recognize that output may be non-obtrusively provided after subsequent instances of “hmm” are uttered and detected.

Conversely, an embodiment may identify that a particular point is considered obtrusive using similar techniques. For example, if the device attempts to provide output and a user interrupts the device, the device may identify that point as obtrusive. The aforementioned methods of identifying a non-obtrusive point may be used individually or in combination. Additionally, persons having ordinary skill in the art will recognize that the examples used in the description of the aforementioned methods are non-limiting.

Responsive to determining, at 303, that assistive output cannot be provided, an embodiment, at 304, performs no additional function. In another embodiment, responsive to identifying that assistive output cannot be provided, an embodiment may continue detecting and/or analyzing conversation-related data.

The various embodiments described herein thus represent a technical improvement to conventional output techniques. Using the techniques described herein, an embodiment may analyze a conversation between users to determine whether assistive output may be provided. An embodiment may then provide the assistive output at a non-obtrusive point in the conversation. Such techniques eliminate the need for users to stop their conversation to activate the device to provide query and/or command input. Additionally, because the system analyzes input for a period of time before the output, the user does not have to restate the query once the device has awakened. In other words, in conventional systems once the user realizes that device output would be helpful, the user has to interrupt the conversation to provide the wake up indication and then restate the query to the device. The systems and methods as described herein does not require this restatement of the query.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, using at least one sensor associated with an information handling device, a conversation between at least two people;
determining whether the information handling device can provide output to assist the at least two people during the conversation; and
providing, responsive to determining that the information handling device can provide output to assist, output at a non-obtrusive point in the conversation.

2. The method of claim 1, wherein the receiving comprises continuously receiving the input by maintaining the at least one sensor in an active state.

3. The method of claim 1, wherein the determining comprises determining while detecting conversation input associated with the conversation.

4. The method of claim 1, wherein the determining is based upon the conversation up to N-number of previous exchanges between the at least two people.

5. The method of claim 1, further comprising identifying the non-obtrusive point in the conversation.

6. The method of claim 5, wherein the identifying the non-obtrusive point comprises identifying at least one discourse marker in the conversation.

7. The method of claim 5, wherein the identifying the non-obtrusive point comprises identifying at least one pause in the conversation.

8. The method of claim 5, wherein the identifying the non-obtrusive point comprises accessing at least one database comprising at least one previously analyzed conversation and comparing the conversation to the previously analyzed conversation.

9. The method of claim 1, wherein the determining comprises identifying a query occurring during the conversation.

10. The method of claim 1, wherein the determining comprises identifying a predetermined phrase used during the conversation, wherein the predetermined phrase is not a wake-up word.

11. An information handling device, comprising:
at least one sensor;
a processor;
a memory device that stores instructions executable by the processor to:
detect a conversation between at least two people;
determine whether the information handing device can provide output to assist the at least two people during the conversation; and
provide, responsive to determining that the information handling device can provide output to assist, output at a non-obtrusive point in the conversation.

12. The information handling device of claim 11, wherein the instructions executable by the processor to receive comprise instructions executable by the processor to continuously receive the input by maintaining the at least one sensor in an active state.

13. The information handling device of claim 11, wherein the instructions executable by the processor to determine comprise instructions executable by the processor to determine while detecting conversation input associated with the conversation.

14. The information handling device of claim 11, where the instructions executable by the processor to determine are based upon the conversation up to N-number of previous exchanges between the at least two people.

15. The information handling device of claim 11, wherein the instructions are further executable by the processor to identify the non-obtrusive point in the conversation.

16. The information handling device of claim 15, wherein the instructions executable by the processor to identify the non-obtrusive point comprise instructions executable by the processor to identify at least one discourse marker in the conversation.

17. The information handling device of claim 15, wherein the instructions executable by the processor to identify the non-obtrusive point comprise instructions executable by the processor to identify at least one pause in the conversation.

18. The information handling device of claim 15, wherein the instructions executable by the processor to identify the non-obtrusive point comprise instructions executable by the processor to access at least one database comprising at least one previously analyzed conversation and wherein the instructions are further executable by the processor to compare the conversation to the previously analyzed conversation.

19. The information handling device of claim 11, wherein the instructions executable by the processor to determine comprise instructions executable by the processor to identify a predetermined phrase used during the conversation, wherein the predetermined phrase is not a wake-up word.

20. A product, comprising:
a storage device that stores code, the code being executable by a processor and comprising:
code that detects a conversation between at least two people;
code that determines whether an information handling device can provide output to assist the at least two people during the conversation; and
code that provides, responsive to determining that the information handling device can provide output to assist, output at a non-obtrusive point in the conversation.
